(19) United States
(12) Patent Application Publication
(10) Pub. No.: US 2020/0089253 A1
(43) Pub. Date: Mar. 19, 2020

(54) MOVING BODY CONTROL APPARATUS, METHOD AND PROGRAM

(71) Applicant: KABUSHIKI KAISHA TOSHIBA, Tokyo (JP)

(72) Inventor: Takashi SUDO, Fuchu Tokyo (JP)

(73) Assignee: KABUSHIKI KAISHA TOSHIBA, TOKYO (JP)

(21) Appl. No.: 16/296,401

(22) Filed: Mar. 8, 2019

(30) Foreign Application Priority Data
Sep. 18, 2018 (JP) 2018-173881

(51) Int. Cl. G05D 1/02; G01S 15/93; B60W 30/09; B60W 30/095

(52) U.S. Cl. CPC G05D 1/0255; G01S 15/931; G05D 1/0221; B60W 2550/306; B60W 30/0953; B60W 30/0956; B60W 2550/302; B60W 30/09

(57) ABSTRACT

According to one embodiment, a moving body control apparatus includes a memory and a hardware processor in communication with the memory. The hardware processor is acquire a sound signal issued by a target, estimate a relative situation between a moving body as a controlled target and the target based on the sound signal, and control driving of the moving body based on the estimated situation.

### CROSS-REFERENCE TO RELATED APPLICATIONS

This application is based upon and claims the benefit of priority from Japanese Patent Application No. 2018-173881, filed Sep. 18, 2018, the entire contents of which are incorporated herein by reference.

### FIELD

Embodiments described herein relate generally to a moving body control apparatus, a method, and a program.

### BACKGROUND

In recent years, an advanced driver-assistance system (ADAS) has been developed in an automotive industry. For example, a method such as moving an own vehicle by performing a power control when an emergency vehicle is detected while the own vehicle is stopped has been considered.

In general, methods such as image recognition using a camera, vehicle detection using extremely high frequency radar, and the like have been used for the detection of the emergency vehicle. However, these methods as described above cannot be used in a case where the emergency vehicle cannot be seen due to another vehicle or a shielding object or in a case where a distance between the own vehicle and the emergency vehicle is long.

Further, in autonomous driving, not only a control for an approach of the emergency vehicle, but also a control for a departure of the emergency vehicle is desired. For example, smooth autonomous driving in which the own vehicle is pulled over to the edge of a lane and stopped when the emergency vehicle comes from behind while traveling, and rapidly returns to an original traveling lane and travels after the emergency vehicle passes, is desired.

### BRIEF DESCRIPTION OF THE DRAWINGS

FIG. 1 is a block diagram showing a schematic configuration of a moving body control apparatus according to a first embodiment.

FIG. 2 is a block diagram showing a functional configuration of each unit of the moving body control apparatus.

FIG. 3 is a diagram for describing a relative situation between an own vehicle and an emergency vehicle.

FIG. 4 is a diagram for describing a relative situation between the own vehicle and the emergency vehicle and shows a state where a time has elapsed from a state shown in FIG. 3.

FIG. 5A is a diagram schematically showing a transition (Example 1) of a positional relationship between the emergency vehicle and the own vehicle and showing a state where the emergency vehicle approaches the own vehicle.

FIG. 5B is a diagram schematically showing the transition (Example 1) and showing a state where the emergency vehicle approaches the own vehicle.

FIG. 5C is a diagram schematically showing the transition (Example 1) and showing a state where the emergency vehicle departs from the own vehicle.

FIG. 5D is a diagram schematically showing the transition (Example 1) and showing a state where the emergency vehicle departs from the own vehicle.

FIG. 6A is a diagram indicating a change in the relative situation between the own vehicle and the emergency vehicle and indicating a change in a volume of a sound input through a mic unit with respect to a time.

FIG. 6B is a diagram indicating a change in a distance (relative distance) estimated in a detection unit with respect to a time.

FIG. 6C is a diagram indicating a change in a speed (another speed) of the emergency vehicle estimated in the detection unit with respect to a time.

FIG. 6D is a diagram indicating a change in a direction (relative direction) of the emergency vehicle estimated in the detection unit with respect to a time.

FIG. 7A is a diagram schematically showing a transition (Example 2) of a positional relationship between the emergency vehicle and the own vehicle and showing a state where the emergency vehicle approaches the own vehicle.

FIG. 7B is a diagram schematically showing the transition (Example 2) and showing a state where the emergency vehicle approaches the own vehicle.

FIG. 7C is a diagram schematically showing the transition (Example 2) and showing a state where the emergency vehicle departs from the own vehicle.

FIG. 7D is a diagram schematically showing the transition (Example 2) and showing a state where the emergency vehicle departs from the own vehicle.

FIG. 8A is a diagram schematically showing a transition (Example 3) of a positional relationship between the emergency vehicle and the own vehicle and showing a state where the emergency vehicle approaches the own vehicle.

FIG. 8B is a diagram schematically showing the transition (Example 3) and showing a state where the emergency vehicle approaches the own vehicle.

FIG. 8C is a diagram schematically showing the transition (Example 3) and showing a state where the emergency vehicle departs from the own vehicle.

FIG. 9A is a diagram indicating a change in the relative situation between the own vehicle and the emergency vehicle and indicating a change in a volume of a sound input through a mic unit with respect to a time.

FIG. 9B is a diagram indicating a change in a distance (relative distance) estimated in the detection unit with respect to a time.

FIG. 9C is a diagram indicating a change in a speed (another speed) of the emergency vehicle estimated in the detection unit with respect to a time.

FIG. 9D is a diagram indicating a change in a direction (relative direction) of the emergency vehicle estimated in the detection unit with respect to a time.

FIG. 10A is a diagram schematically showing a transition of a positional relationship between a crossing of a railroad and a own vehicle according to a second embodiment and showing a state where a own vehicle moves toward a crossing of a railroad.

FIG. 10B is a diagram showing a state where the own vehicle is stopped in front of the railroad.

FIG. 10C is a diagram showing a state where the own vehicle passes through the crossing of the railroad.

FIG. 11A is a diagram indicating a change in a relative situation between the own vehicle and warning devices and indicating a change in a volume of a sound input through a mic unit with respect to a time.

FIG. 11B is a diagram indicating a change in a distance (relative distance) estimated in the detection unit with respect to a time.

FIG. 11C is a diagram indicating a change in a speed (another speed) of the warning devices estimated in the detection unit with respect to a time.

FIG. 11D is a diagram indicating a change in a relative direction of the warning devices estimated in the detection unit with respect to a time.

FIG. 12 is a diagram showing an example of a hardware configuration of each of control apparatuses according to the first and second embodiments.

FIG. 13 is a flowchart showing a processing operation of the control apparatus.

FIG. 14 is a diagram showing an example of a self-propelled robot as a modified example.

FIG. 15 is a diagram showing an example of a flight vehicle as a modified example.

### DETAILED DESCRIPTION

Hereinafter, embodiments will be described with reference to the drawings.

In general, according to one embodiment, a moving body control apparatus includes a memory and a hardware processor in communication with the memory. The hardware processor is acquire a sound signal issued by a target, estimate a relative situation between a moving body as a controlled target and the target based on the sound signal, and control driving of the moving body based on the estimated situation.

### First Embodiment

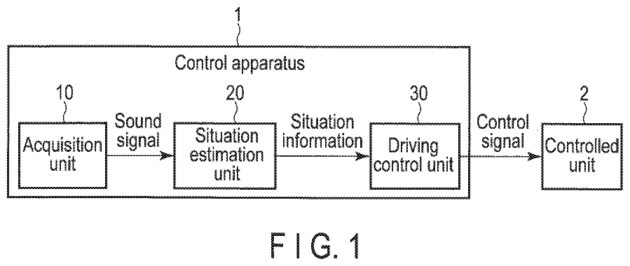

FIG. 1 is a block diagram showing a schematic configuration of a moving body control apparatus according to a first embodiment. The moving body control apparatus according to the present embodiment controls driving of a moving body as a control target. Examples of the moving body include a vehicle moving on the ground (on a road or the like), a flight vehicle moving in the air, a vessel moving through the water, a submarine going underground inside of sea, and the like.

Hereinafter, a vehicle will be described as the moving body by way of example.

A vehicle (hereinafter, referred to as an own vehicle) as a control target includes a control apparatus 1. The control apparatus 1 has a function of detecting an emergency vehicle as a target and controlling driving of the own vehicle. Examples of the type of emergency vehicle include an “ambulance”, a “fire truck”, a “police patrol vehicle” (hereinafter, abbreviated as a patrol car), and the like. These emergency vehicles output, that is, issue, sound signals (warning sound) having a plurality of patterns each of which has a certain frequency band, at a predetermined volume.

As shown in FIG. 1, the control apparatus 1 includes an acquisition unit 10, a situation estimation unit 20, and a driving control unit 30.

The acquisition unit 10 acquires a sound around the own vehicle which is input through a microphone (hereinafter, abbreviated as a mic), and outputs a sound signal, which is a digital signal, to the situation estimation unit 20 by analog-to-digital converter (ADC). For example, a sampling frequency at the time of ADC is 16 kHz.

The situation estimation unit 20 detects, from the sound signal, a warning sound of the emergency vehicle which is a target of the own vehicle. The situation estimation unit 20 estimates a relative situation between the own vehicle (moving body) and the emergency vehicle (target) based on the detected warning sound, and outputs the estimated relative situation to the driving control unit 30. The relative situation includes at least one of a relative direction, a relative speed, and a relative distance of the target with respect to the moving body.

The driving control unit 30 controls driving of the own vehicle with respect to the emergency vehicle based on a change in the relative situation estimated by the situation estimation unit 20. A controlled unit 2 performs a control of power (engine) or a handle of the own vehicle based on a control signal output from the driving control unit 30.

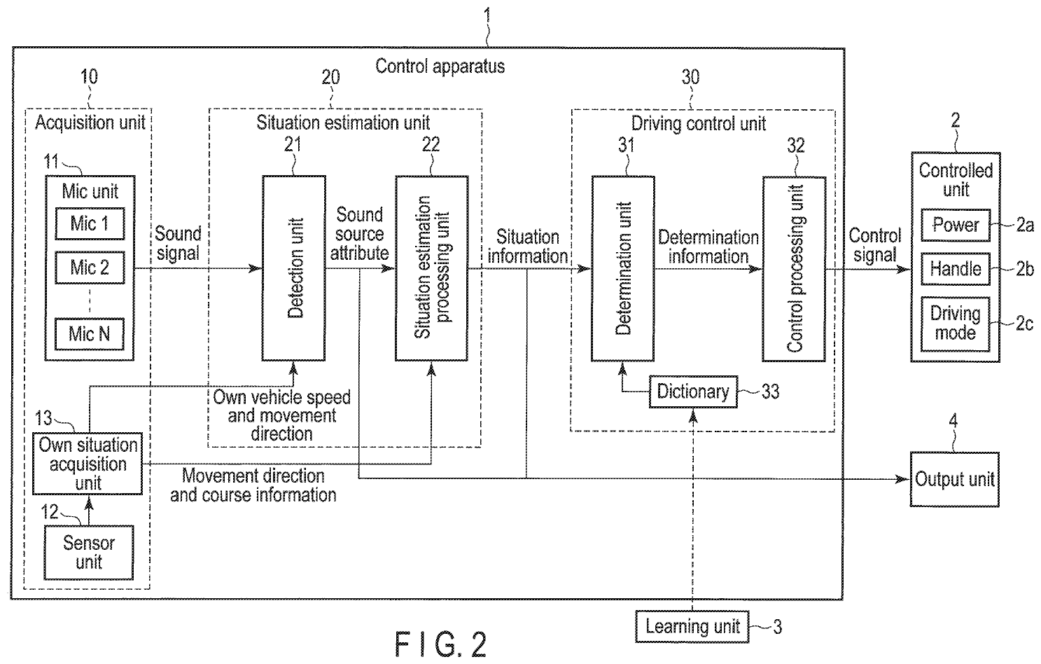

FIG. 2 is a block diagram showing a functional configuration of each unit of the moving body control apparatus.

As described above, the acquisition unit 10, the situation estimation unit 20, and the driving control unit 30 are provided in the control apparatus 1.

### [Acquisition Unit]

The acquisition unit 10 includes a mic unit 11, a sensor unit 12, and an own situation acquisition unit 13.

The mic unit 11 includes N mics. N is a natural number. Each of the N mics includes an ADC, and collects a sound around the own vehicle and outputs, to the situation estimation unit 20, a sound signal (digital signal) time-synchronized across N channels. It should be noted that the number of mics may be at least one. In addition, the mic may be installed at an arbitrary portion in the own vehicle, or may not be installed in the own vehicle when the sound around the own vehicle can be collected during the driving of the own vehicle.

The sensor unit 12 includes various types of sensors for detecting the situation of the own vehicle. In detail, the sensor unit 12 includes at least one of, for example, a speed meter, an acceleration sensor, and a mechanism sensing the number of rotations of a tire, as a sensor for detecting a speed of the own vehicle.

Further, the sensor unit 12 includes at least one of, for example, a steering wheel (handle) and a gyro sensor, as a sensor for detecting a movement direction of the own vehicle. In addition, the sensor unit 12 includes, for example, a global positioning system (GPS) sensor, as a sensor for detecting positional information of the own vehicle.

The own situation acquisition unit 13 inputs information (hereinafter, referred to as own situation information) on the situation of the own vehicle through the sensor unit 12. The own situation information includes at least one of a speed of the own vehicle, a movement direction of the own vehicle, and a current position of the own vehicle.

In detail, the own situation acquisition unit 13 obtains a speed (own speed) of the own vehicle from a detection signal from, for example, the speed meter, the acceleration sensor, or the mechanism sensing the number of rotations of the tire and outputs the obtained speed to the situation estimation unit 20. In addition, the own situation acquisition unit 13 obtains a movement direction of the own vehicle from a detection signal from, for example, the steering wheel (handle) or the gyro sensor and outputs the obtained movement direction of the own vehicle to the situation estimation unit 20. Further, the own situation acquisition unit 13 obtains positional information of the own vehicle from the GPS sensor. Here, the own situation acquisition unit 13 combines the positional information of the own vehicle with positional information of a destination set in a car navigation system (not shown) and map information, thereby outputting, to the situation estimation unit 20, information of a route from a current position of the own vehicle to the destination.

### [Situation Estimation Unit]

The situation estimation unit 20 includes a detection unit 21 and a situation estimation processing unit 22.

The detection unit 21 determines whether or not the warning sound of the emergency vehicle arrives based on the sound signal output from the mic unit 11. At this time, a plurality of warning sounds of the emergency vehicle may be registered and the type of warning sound (the type of sound source) may be recognized.

For example, a dictionary in which characteristic patterns of three types of warning sounds of the “ambulance”, the “fire truck”, and the “patrol car” are registered is prepared in advance. A characteristic value is extracted from the sound signal, and a characteristic pattern obtained by pattern recognition processing of a deep neural network (DNN) or the like and the respective characteristic patterns registered in the dictionary are compared to each other, such that the type of warning sound is recognized.

When the warning sound of the emergency vehicle arrives, the detection unit 21 calculates a volume of the warning sound from the sound signal and estimates a relative distance between the own vehicle and the emergency vehicle based on the volume of the warning sound. In addition, the detection unit 21 performs direction estimation processing such as multiple signal classification (MUSIC) method or the like for a multi-channel sound signal, thereby calculating a direction of the emergency vehicle when viewed from the own vehicle, that is, a relative direction between the own vehicle and the emergency vehicle. Further, the detection unit 21 has a function capable of detecting a change in a frequency of the sound signal caused by the Doppler effect.

Here, a direction from the emergency vehicle to the own vehicle is a positive direction. A frequency f [Hz] of the warning sound of the emergency vehicle observed by the own vehicle is represented by the following Equation (1) based on the frequency change caused by the Doppler effect.

f=f0×(V−v0)/(V−vs) (1)

V represents a velocity of sound and is approximately 340 [m/s] at 15° C.

f0 represents a frequency [Hz] of the warning sound of the emergency vehicle and is known in advance.

v0 represents a speed [m/s] of the own vehicle in a direction from the emergency vehicle to the own vehicle.

vs represents a speed (hereinafter, referred to as another speed) [m/s] of the emergency vehicle in the direction from the emergency vehicle to the own vehicle.

The detection unit 21 calculates v0 based on the movement direction of the own vehicle obtained from the own situation acquisition unit 13 and the relative direction between the own vehicle and the emergency vehicle. In addition, the detection unit 21 calculates vs based on Equation (1) above by using the frequency f0 of the warning sound of the emergency vehicle.

As described above, the detection unit 21 calculates at least one of the type of sound source, the relative distance, the relative direction, and the relative speed, and outputs the calculation result to the situation estimation processing unit 22 as a sound source attribute of the warning sound of the emergency vehicle.

At this time, a fact that the warning sound of the emergency vehicle is detected and the sound source attribute of the warning sound may be output together from an output unit 4, such that a user may visually or aurally recognize the fact and the sound source attribute. The output unit 4 may be any one or more of, for example, a display and a speaker. The display and the speaker may be installed at, for example, an arbitrary portion in the own vehicle.

The situation estimation processing unit 22 obtains a change in a relative speed vector (an arrival direction and a speed) based on the sound source attribute of the warning sound obtained from the detection unit 21 and the movement direction of the own vehicle obtained from the own situation acquisition unit 13. The situation estimation processing unit 22 predicts a future positional relationship between the own vehicle and the emergency vehicle based on the change in the relative speed vector, and outputs information on a future (near future) situation to the driving control unit 30.

In detail, the situation estimation processing unit 22 estimates the following situations by using the relative distance, the relative direction, another speed, the movement direction of the own vehicle, and a own vehicle speed.

“The emergency vehicle approaches/departs from the front/behind/the right/the left of the own vehicle.”

“The emergency vehicle present in front of/behind/on the right of/on the left of the own vehicle is stopped.”

“The emergency vehicle stopped in front of/behind/on the right of/on the left of the own vehicle travels and approaches/departs from the own vehicle.”

At this time, accuracy of prediction of the positional relationship between the own vehicle and the emergency vehicle and the situation information, by considering the route information of the own vehicle obtained from the own situation acquisition unit 13.

A specific example of the processing of the situation estimation unit 20 will be described.

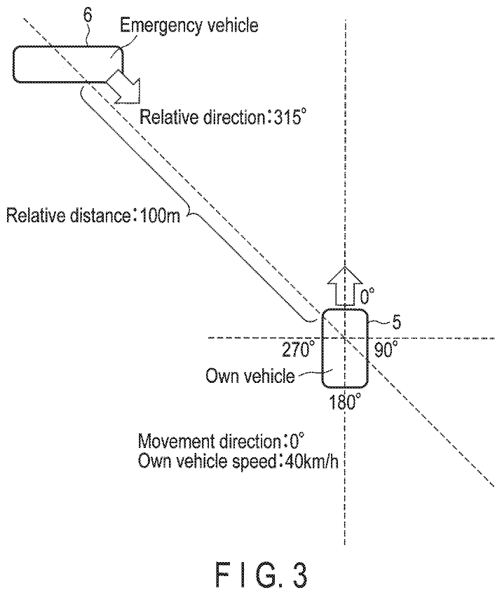

FIGS. 3 and 4 are diagrams for describing relative situations between the own vehicle and the emergency vehicle. Reference numeral 5 in the drawings indicates the own vehicle, and Reference numeral 6 indicates the emergency vehicle. A movement direction of the own vehicle 5 is set to 0° and a clockwise direction is represented by an angle. For example, the emergency vehicle 6 is an ambulance, and a warning sound of the ambulance is repetition of frequencies of 800 [Hz] and 1000 [Hz].

FIG. 3 shows an example in which an own vehicle speed is 40 [km/h], a relative direction between the own vehicle 5 and the emergency vehicle 6 is 315°, and a relative distance is 100 [m].

A speed v0 of the own vehicle 5 in a direction from the emergency vehicle 6 to the own vehicle 5 is calculated as follows.

v0=40×cos(360°−315°) [km/h]≈7.86 [m/s]

In addition, when the observed warning sound of the emergency vehicle 6 is 760 [Hz] and 950 [Hz], another speed vs is approximately −9.62 [m/s]. Therefore, it can be estimated that the emergency vehicle 6 traveling at 34.6 [km/h] approaches the own vehicle 5.

FIG. 4 shows a state where a time has elapsed from the state shown in FIG. 3. FIG. 4 shows an example in which the own vehicle speed of 40 [km/h] is maintained, the relative distance between the own vehicle 5 and the emergency vehicle 6 is 50 [m], and the relative direction between the own vehicle 5 and the emergency vehicle 6 is 330°.

In a case where the emergency vehicle 6 travels at a constant speed, it can be predicted that the emergency vehicle 6 approaches the own vehicle 5 from the substantially front (0° direction) of the own vehicle 5 after t seconds.

t=50 [m]/(7.86+9.62) [m/s]≈2.8 [s]

The detection unit 21 may detect a traveling sound or a warning klaxon of a surrounding vehicle. When the traveling sound of the surround vehicle is detected, the situation estimation processing unit 22 estimates relative positional information, a relative speed vector of the surrounding vehicle, a distance between the own vehicle 5 and the surrounding vehicle, and the like by using a video and extremely high frequency radar together. At this time, the situation in which the surrounding vehicle approaches may be displayed on a display (not shown) provided in the own vehicle 5 to enable visual recognition of the user. In addition, the situation in which the surrounding vehicle approaches may also be output as a voice from a speaker (not shown) provided in the own vehicle 5.

When the warning klaxon of the surrounding vehicle is detected, the situation estimation processing unit 22 determines whether or not the own vehicle is related to the warning klaxon of the surrounding vehicle based on the relative speed vector. Even in this case, the relationship between the surrounding vehicle and the own vehicle may be displayed or announced as a voice, thereby notifying the user.

### [Driving Control Unit]

The driving control unit 30 includes a determination unit 31 and a control processing unit 32, and a dictionary 33. A parameter set of a determination algorithm learned by a learning unit 3 to be described below is stored in the dictionary 33.

Here, the learning unit 3 will be described.

The learning unit 3 is provided independently of the control apparatus 1. The learning unit 3 learns a relationship between a relative situation between the own vehicle and the emergency vehicle and an ideal driving control of the own vehicle on a movement route of the own vehicle in advance.

In detail, the learning unit 3 acquires information on various roads on the route on which the own vehicle moves from the map information in advance, and has an input data group in which relative situations between the own vehicle and the emergency vehicle on these roads are assumed, and a correct data group for performing the ideal driving control of the own vehicle in the respective situation, in pairs.

The learning unit 3 learns the parameter set of the determination algorithm used in the determination unit 31 to minimize a deviation between an output data group of the determination unit 31 to the input data group and the correct data group to the input data group. The dictionary 33 stores the learned parameter set of the determination algorithm therein.

For example, the dictionary 33 stores a parameter set λ expressing a function f which is the determination algorithm minimizing a deviation |Y−f(X)|² in which X indicates the input data group, Y indicates the correct data group, and the function f indicates the determination algorithm, therein. By doing so, when situation information x0 belonging to the input data group X is input to the determination unit 31, the determination unit 31 can output, to the control processing unit 32, determination information (information for performing the ideal driving control) f(x0) obtained from the parameter set λ with reference to the dictionary 33.

It should be noted that a sound signal may be included in the input data group and learned. For example, a change in a positional relationship and a relative speed vector (an arrival direction and a speed) between the own vehicle and the emergency vehicle in various patterns, and a sound input through the mic are included in the input data group. The ideal driving control of the own vehicle for the input data group is associated in time series and learned as the correct data group. As described later, the driving control of the own vehicle is direction determination by a handle, starting and stopping of a power engine, or the like.

In addition, a start of the driving control caused by an approach of the emergency vehicle and a termination of the driving control caused by a departure of the emergency vehicle may be associated with each other and learned. In this case, an optimal driving control of start and end of waiting when a vehicle which simulates the emergency vehicle is driven and passes near the own vehicle from various directions on a road of each region, may be derived by a driving operation of a person, and the derived optimal driving control may be learned as the correct data group.

In addition, a correct data group related to a driving control of the own vehicle corresponding to each weather such as clear weather, rainy weather, and snowy weather may be learned, in addition to weather information.

The determination unit 31 receives the situation information obtained by the situation estimation processing unit 22. The determination unit 31 obtains determination information corresponding to the situation information based on the parameter set read from the dictionary 33 and outputs the obtained determination information to the control processing unit 32.

In detail, the determination unit 31 receives the situation information estimated from the warning sound of the emergency vehicle. The determination unit 31 specifies a corresponding relationship between the approach or departure of the emergency vehicle and the own vehicle obtained from the situation information based on a learning result of the learning unit 3, thereby determining a timing of the start or end of the driving control of the own vehicle.

In this case, when a volume of the warning sound of the emergency vehicle is increased, it is estimated that the own vehicle is in the situation in which the emergency vehicle approaches and the traveling of the own vehicle is stopped. Then, when the volume of the warning sound of the emergency vehicle is decreased, it is assumed that the own vehicle is in the situation in which the emergency vehicle departs, and such control of terminating the stop of the traveling, and returning the own vehicle to normal driving can be easily estimated. As described above, more ideal and smoother autonomous driving can be realized by performing machine learning of the start or end of the driving control of the own vehicle with the approach/departure of the emergency vehicle.

The control processing unit 32 receives the determination information obtained by the determination unit 31, and outputs a control signal for controlling driving of the controlled unit 2 based on the determination information.

The controlled unit 2, which is a portion related to the driving control of the own vehicle, includes power 2a, a handle 2b, and a driving mode 2c. The power 2a, the handle 2b, and the driving mode 2c are controlled by the control signal output from the control apparatus 1.

The control signal for the power 2a includes a degree of a speed, such as a stop, an acceleration, and a deceleration.

The control signal for the handle 2b includes a degree of a direction, such as a left direction and a right direction.

The control signal for the driving mode 2c includes ON and OFF of an emergency vehicle detection mode.

When the emergency vehicle detection mode is in the OFF state, the own vehicle is in a normal driving mode. In this case, the driving of the own vehicle is controlled by additionally considering sensor information such as a video or extremely high frequency radar so that, for example, the own vehicle does not cross over white lines on both sides of a lane. When the emergency vehicle detection mode is in the ON state, the own vehicle is in an autonomous driving mode in which the approach/departure of the emergency vehicle is considered. A driving control in which the crossing of the own vehicle over the white lines on both sides of the lane is permitted is performed. For example, the own vehicle is stopped at a left side of a road shoulder as the emergency vehicle approaches.

It should be noted that determination of a situation and a control therefor are performed successively. For example, when the emergency vehicle approaches the own vehicle from behind the own vehicle, the handle 2b is turned to the left to stop the own vehicle at the left side of the road shoulder and the power 2a is stopped. When the emergency vehicle passes by the vicinity of the own vehicle, the stop of the power 2a is canceled, and the handle 2b is turned to the right to start traveling. Like this, the determination of the situation and the control therefor are successively performed.

Hereinafter, specific examples of a movement of the own vehicle controlled by the driving control unit 30 will be described.

### (Example 1) A Case where the Emergency Vehicle Approaches the Own Vehicle from Behind the Own Vehicle

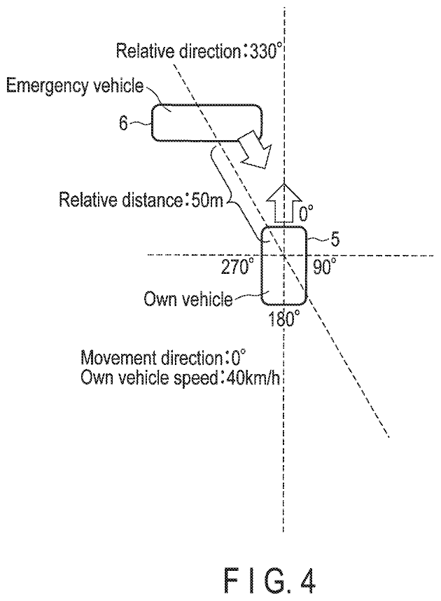

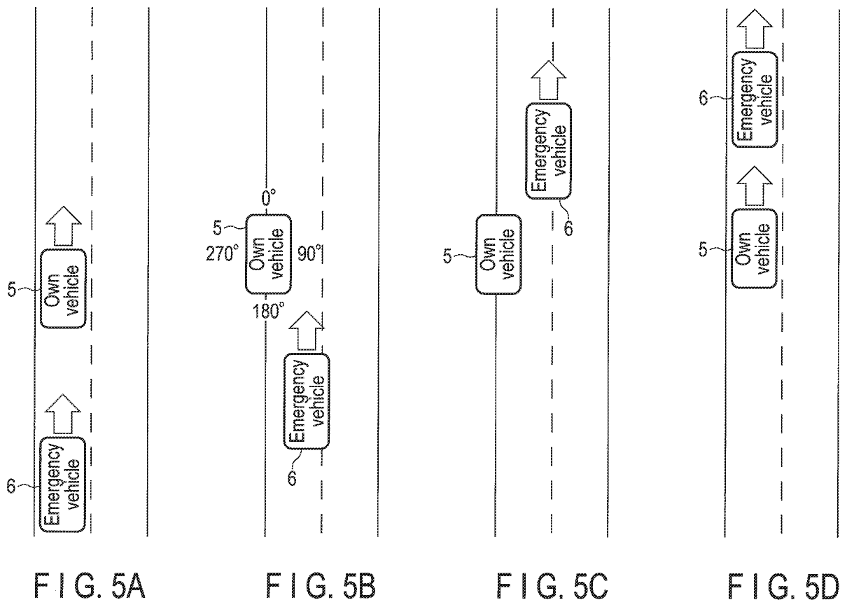

FIGS. 5A to 5D are diagrams schematically showing a transition (Example 1) of a positional relationship between the emergency vehicle and the own vehicle.

FIGS. 5A and 5B show a state where the emergency vehicle approaches the own vehicle, and FIGS. 5C and 5D show a state where the emergency vehicle departs from the own vehicle.

As shown in FIG. 5A, the own vehicle 5 travels on the left side of a two-lane road. The own vehicle 5 includes the control apparatus 1 described with reference to FIGS. 1 and 2.

Here, a case where the emergency vehicle 6 approaches the own vehicle 5 from behind the own vehicle 5 while issuing a warning sound is assumed.

When detecting the warning sound of the emergency vehicle 6, the control apparatus 1 controls the own vehicle 5 to be pulled over to the edge of a lane and stops the own vehicle 5 as shown in FIG. 5B.

The own vehicle 5 is pulled over to the left edge (270° direction) of the lane in the example of FIG. 5B, but the own vehicle 5 is pulled over to the right edge (90° direction) of the lane in some cases. In short, the own vehicle 5 may be stopped at a place where the own vehicle 5 does not hinder the traveling of the emergency vehicle 6. A place of the lane at which the own vehicle 5 is pulled over may be determined depending on a surrounding situation such as a width of lane, the opposite vehicle, and the like.

As shown in FIG. 5C, the own vehicle 5 is in a temporary stop state for a period during which the emergency vehicle 6 passes by the own vehicle 5 to the front of the own vehicle 5 (in a direction different from the direction in which the emergency vehicle 6 approaches). Then, when the emergency vehicle 6 completely passes by the own vehicle 5, the own vehicle 5 returns to an original traveling lane and restarts driving as shown in FIG. 5D.

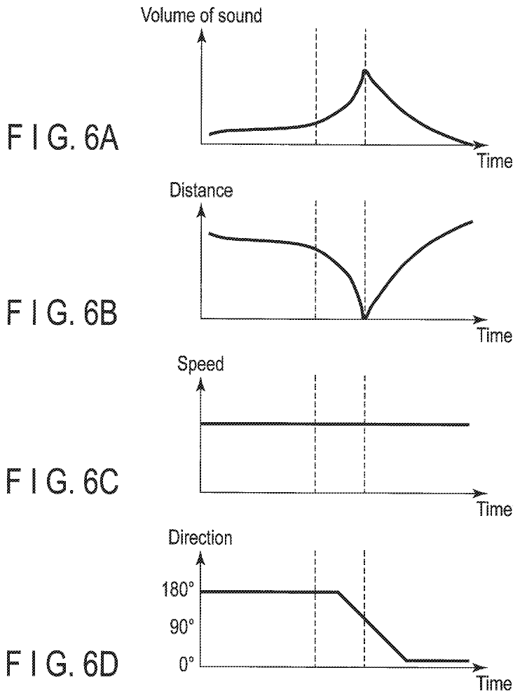

FIGS. 6A to 6D are diagrams indicating a change in the relative situation between the own vehicle 5 and the emergency vehicle 6 shown in FIGS. 5A to 5D. FIG. 6A indicates a change in a volume of a sound input through the mic unit 11 with respect to a time. FIG. 6B indicates a change in a distance (relative distance) estimated in the detection unit 21 with respect to a time. FIG. 6C indicates a change in a speed (another speed) of the emergency vehicle 6 estimated in the detection unit 21 with respect to a time. FIG. 6D indicates a change in a direction (relative direction) of the emergency vehicle 6 estimated in the detection unit 21 with respect to a time.

First, when the emergency vehicle 6 approaches the own vehicle 5, it is estimated that the emergency vehicle 6 approaches the own vehicle 5 from the back (180°) of the own vehicle 5 in the relative direction with respect to the own vehicle 5 based on a direction of the warning sound issued by the emergency vehicle 6 (a state shown in FIG. 5A). At this time, a relative distance between the own vehicle 5 and the emergency vehicle 6 is estimated based on a change in a volume of the warning sound of the emergency vehicle 6, and a speed (another speed) of the emergency vehicle 6 is also estimated in consideration of the Doppler effect.

Here, when the relative distance between the own vehicle 5 and the emergency vehicle 6 is decreased, and it is estimated by the situation estimation processing unit 22 that the emergency vehicle 6 catches up with the own vehicle 5, a control signal for a temporary stop is output from the driving control unit 30 to the controlled unit 2. As a result, the own vehicle 5 is stopped at the edge of the lane (a state shown in FIG. 5B).

The own vehicle 5 is in the temporary stop state for a period during which the emergency vehicle 6 passes by the own vehicle 5 from the back (180°) of the own vehicle 5 to the front (0°) of the own vehicle 5 (a state shown in FIG. 5C). When the emergency vehicle 6 completely passes by the own vehicle 5 to the front of the own vehicle 5, a control signal for restarting the driving is output from the driving control unit 30 to the controlled unit 2. As a result, the own vehicle 5 returns to the original traveling lane and restarts traveling (a state shown in FIG. 5D). In this example, the start and end of the driving of the own vehicle 5 is controlled based on the change in the relative speed vector.

### (Example 2) A Case where the Emergency Vehicle Approaches the Own Vehicle from Behind the Own Vehicle (Other Vehicles are Present)

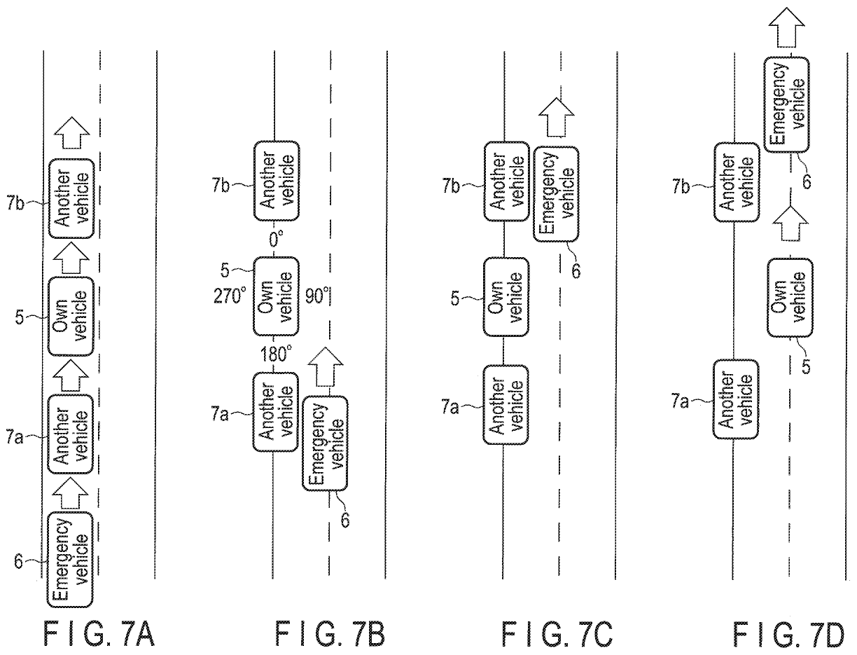

FIGS. 7A to 7D are diagrams schematically showing a transition (Example 2) of a positional relationship between the emergency vehicle and the own vehicle.

FIGS. 7A and 7B show a state where the emergency vehicle approaches the own vehicle, and FIGS. 7C and 7D show a state where the emergency vehicle departs from the own vehicle.

Unlike the example of FIGS. 5A to 5D, other vehicles 7a and 7b are present in front of and behind the own vehicle 5. Another vehicle 7a is positioned behind (180°) the own vehicle 5 and another vehicle 7b is positioned in front (0°) of the own vehicle 5. FIGS. 7A to 7D correspond to FIGS. 5A to 5D, respectively.

For example, it is likely that a detection system using a camera cannot detect the approach/departure of the emergency vehicle 6 when other vehicles 7a and 7b are present in front of and behind the own vehicle 5. Whereas, the present system detects a peculiar sound signal (warning sound) of the emergency vehicle 6 to estimate a relative situation between the own vehicle 5 and the emergency vehicle 6. Therefore, the present system can detect the approach/departure of the emergency vehicle 6 with high accuracy even when other vehicles 7a and 7b are present in front of and behind the own vehicle 5.

In order to prevent the own vehicle 5 from colliding with other vehicles 7a and 7b present in front of and behind the own vehicle 5, the driving of the own vehicle 5 is controlled by additionally considering sensor information, for example, a video, extremely high frequency radar, or the like.

### (Example 3) A Case where the Emergency Vehicle Approaches the Own Vehicle from the Left of the Own Vehicle (Other Vehicles are Present)

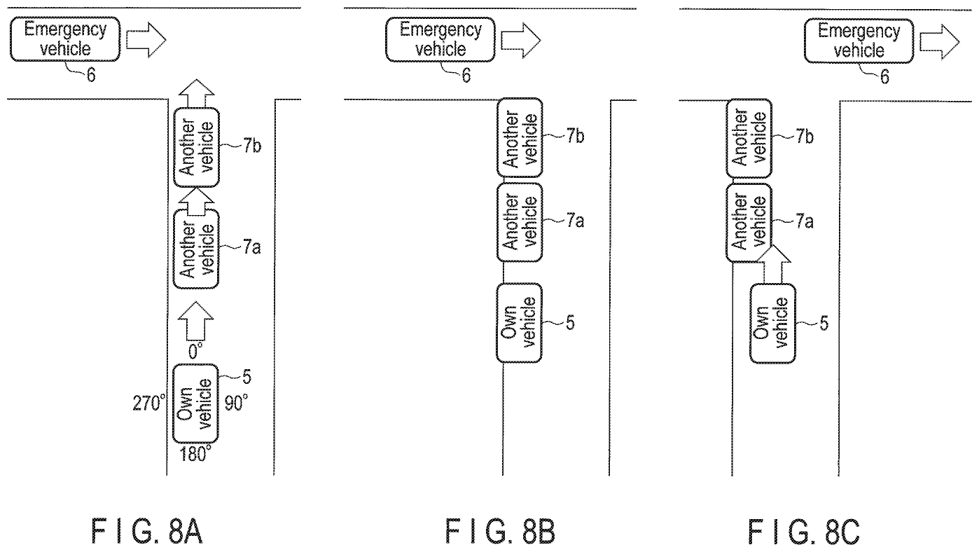

FIGS. 8A to 8C are diagrams schematically showing a transition (Example 3) of a positional relationship between the emergency vehicle and the own vehicle. FIGS. 8A and 8B show a state where the emergency vehicle approaches the own vehicle, and FIG. 8C shows a state where the emergency vehicle departs from the own vehicle.

As shown in FIG. 8A, the own vehicle 5 and other vehicles 7a and 7b travel toward, for example, a T-intersection. The own vehicle 5 includes the control apparatus 1 described with reference to FIGS. 1 and 2. Other vehicles 7a and 7b are traveling ahead in front (0°) of the own vehicle 5.

Here, a case where the emergency vehicle 6 approaches the own vehicle 5 from the left of the intersection to the front of the own vehicle 5 while issuing a warning sound is assumed. When detecting the warning sound of the emergency vehicle 6, the control apparatus 1 controls the own vehicle 5 to be pulled over to the edge of a lane and stops the own vehicle 5 as shown in FIG. 8B. As described above, at which place of the lane the own vehicle 5 is pulled over may be determined depending on a surrounding situation such as a width of lane, the opposite vehicle, and the like.

The own vehicle 5 is in the temporary stop state for a period during which the emergency vehicle 6 passes by the own vehicle 5 to the front-right, the front, or behind the own vehicle 5 (in a direction different from the direction in which the emergency vehicle 6 approaches). Then, when the emergency vehicle 6 completely passes by the own vehicle 5, the own vehicle 5 returns to an original traveling lane and restarts driving as shown in FIG. 8C.

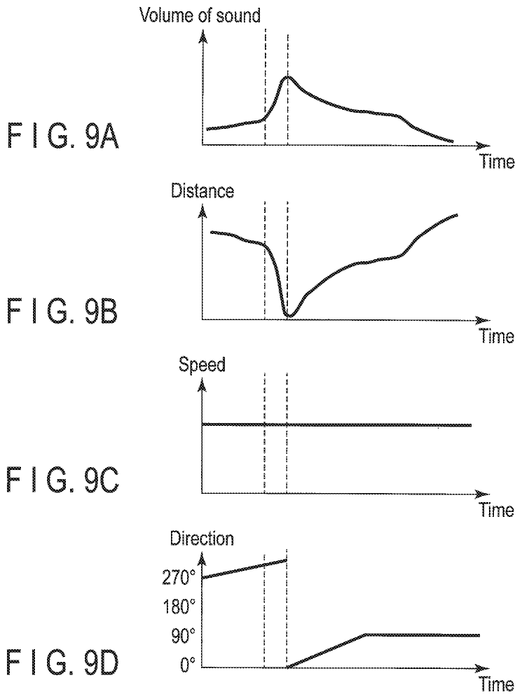

FIGS. 9A to 9D are diagrams indicating a change in the relative situation between the own vehicle 5 and the emergency vehicle 6 shown in FIGS. 8A to 8C. FIG. 9A indicates a change in a volume of a sound input through the mic unit 11 with respect to a time. FIG. 9B indicates a change in a distance (relative distance) estimated in the detection unit 21 with respect to a time. FIG. 9C indicates a change in a speed (another speed) of the emergency vehicle 6 estimated in the detection unit 21 with respect to a time. FIG. 9D indicates a change in a direction (relative direction) of the emergency vehicle 6 estimated in the detection unit 21 with respect to a time.

First, when the emergency vehicle 6 approaches the own vehicle 5, it is estimated that the emergency vehicle 6 approaches the own vehicle 5 from the front-left (270°) of the own vehicle 5 in the relative direction with respect to the own vehicle 5 based on a direction of the warning sound issued by the emergency vehicle 6 (a state shown in FIG. 8A). At this time, a relative distance between the own vehicle 5 and the emergency vehicle 6 is estimated based on a change in a volume of the warning sound of the emergency vehicle 6, and a speed (another speed) of the emergency vehicle 6 is also estimated in consideration of the Doppler effect.

Here, when the relative distance between the own vehicle 5 and the emergency vehicle 6 is decreased and it is estimated by the situation estimation processing unit 22 that the emergency vehicle 6 arrives in the vicinity of the own vehicle 5, a control signal for a temporary stop is output from the driving control unit 30 to the controlled unit 2. As a result, the own vehicle 5 is stopped at the edge of the lane (a state shown in FIG. 8B). In this case, the driving control unit 30 controls the driving of the own vehicle 5 by additionally considering sensor information such as a video or extremely high frequency radar so that the own vehicle 5 does not collide with another vehicle 7b traveling in front of the own vehicle 5.

The own vehicle 5 is in the temporary stop state for a period during which the emergency vehicle 6 passes by the own vehicle 5 from the front (0°) of the own vehicle 5 to the front-right (15°) of the own vehicle 5. When the emergency vehicle 6 completely passes by the own vehicle 5 to the front-right of the own vehicle 5, a control signal for restarting the driving is output from the driving control unit 30 to the controlled unit 2. As a result, the own vehicle 5 returns to the original traveling lane and restarts traveling (a state shown in FIG. 8C).

As described above, according to the first embodiment, the situation estimation processing focusing on the peculiar sound signal (warning signal) of the emergency vehicle 6 is performed by the control apparatus 1 including the acquisition unit 10, the situation estimation unit 20, and the driving control unit 30.

That is, a relative situation (a direction, a speed, and a distance) between the own vehicle 5 and the emergency vehicle 6 is estimated by using the sound signal, and the driving of the own vehicle 5 is controlled based on the estimated relative situation. By doing so, it is possible to realize smooth autonomous driving in which the own vehicle 5 is pulled over to the edge of a lane to let the emergency vehicle 6 passes when the emergency vehicle 6 approaches the own vehicle 5, and the own vehicle 5 rapidly returns to the original traveling lane and travels after the emergency vehicle 6 passes.

In general, methods such as image recognition using a camera, vehicle detection using extremely high frequency radar or Lidar (Light detection and ranging), and the like have been used for the detection of the emergency vehicle. However, these methods as described above cannot be used in a case where the emergency vehicle 6 cannot be seen due to another vehicle or a shielding object, or in a case where a distance between the own vehicle 5 and the emergency vehicle 6 is long. Whereas, in the present embodiment, the situation can be estimated by using the sound signal, and it is thus possible to realize the smooth autonomous driving as described above.

Further, the situation estimation processing is performed in consideration of the own situation information (a speed, a movement direction, a current position, and the like) of the own vehicle 5, which can be obtained by the own situation acquisition unit 13, such that it is possible to accurately estimate the relative situation between the own vehicle 5 and the emergency vehicle 6 and realize the autonomous driving with high accuracy.

In addition, the ideal driving control corresponding to the relative situation between the own vehicle 5 and the emergency vehicle 6 is learned by using the learning unit 3, such that it is possible to realize the autonomous driving corresponding to various situations with high accuracy.

### Second Embodiment

Next, a second embodiment will be described.

In the first embodiment, the case where an emergency vehicle is a target, and driving of a own vehicle is controlled by acquiring a sound signal from the emergency vehicle has been described, but the target is not limited to the emergency vehicle and the method of the present invention can be applied to any object as long as the object issues a certain sound signal. In addition, the target may also be a non-moving body.

Hereinafter, a case where a warning device installed in a crossing of a railroad is a target, and driving of an own vehicle is controlled by acquiring a warning sound generated from the warning device will be described as the second embodiment.

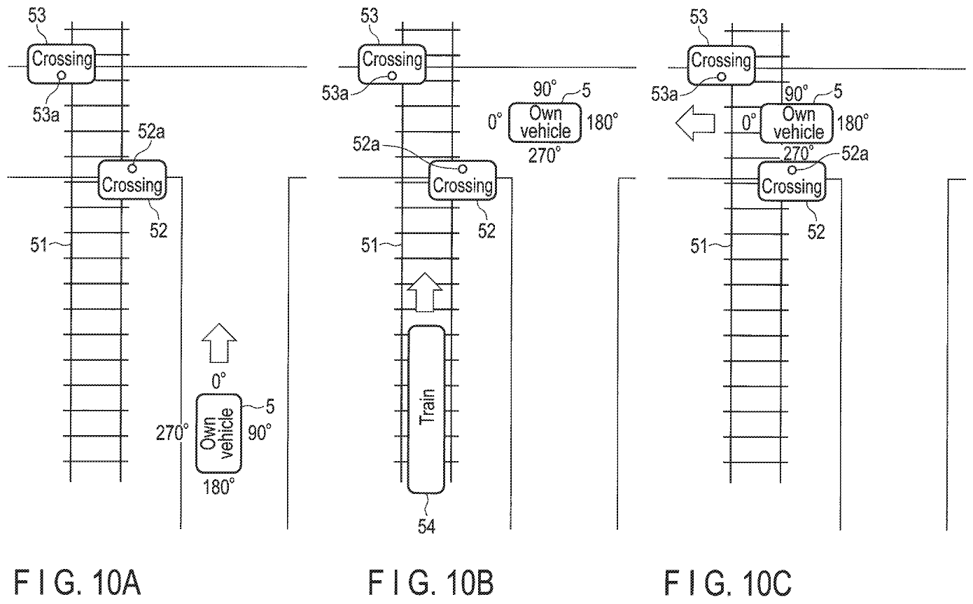

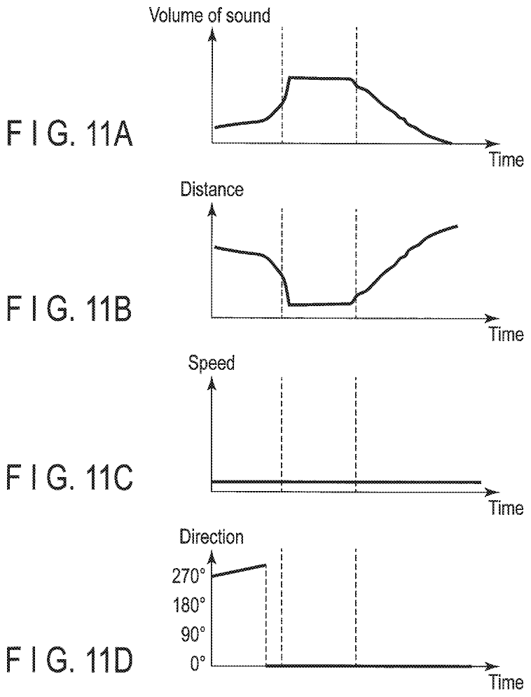

Since a configuration of a control apparatus 1 is the same as shown in FIGS. 1 and 2, an operation of a driving control unit 30 included in the control apparatus 1 will be described hereinafter with reference to FIGS. 10A to 11C, and FIGS. 11A to 11D.

FIGS. 10A to 10C are diagrams schematically showing a transition of a positional relationship between a crossing of a railroad and an own vehicle according to the second embodiment. FIG. 10A shows a state where an own vehicle moves toward a crossing of a railroad, FIG. 10B shows a state where the own vehicle is stopped in front of the railroad, and FIG. 10C shows a state where the own vehicle passes through the crossing of the railroad.

Warning devices 52a and 53a are installed in crossings 52 and 53 of a railroad 51. The warning devices 52a and 53a issue a sound signal (warning sound) having a certain frequency band at a predetermined volume at a predetermined time (for example, 60 seconds) before a train 54 reaches the crossings 52 and 53. The warning devise 52a and 53a simultaneously issue a warning sound with the approach of the train 54.

As shown in FIG. 10A, an own vehicle 5 travels toward the crossings 52 and 53. The own vehicle 5 includes the control apparatus 1 described with reference to FIGS. 1 and 2.

When the own vehicle 5 approaches the crossings 52 and 53, the control apparatus 1 detects the warning sound of the warning devices 52a and 53a. At this time, a fact that the warning sound is detected may be displayed on a display (not shown) provided in the own vehicle 5 to enable visual recognition of a user (driver). In addition, the fact that the warning sound is detected may also be output as a voice from a speaker (not shown) provided in the own vehicle 5. When the own vehicle 5 travels straight toward an intersection, it is determined that the warning sound comes from the left (270°) of the own vehicle 5 in a relative direction.

Here, as shown in FIG. 10B, when the own vehicle 5 turns left at the intersection, it is determined that the warning sound comes from the front (0°) of the own vehicle 5 in the relative direction. When the own vehicle 5 approaches the warning devices 52a and 53a which are warning sound sources, the control apparatus 1 temporarily stops the own vehicle 5 and waits until the train 54 passes. As shown in FIG. 10C, when the train 54 passes and the warning sound of the warning devices 52a and 53a is stopped, the driving of the own vehicle 5 restarts.

FIGS. 11A to 11D are diagrams indicating a change in the relative situation between the own vehicle 5 and the warning devices 52a and 53a shown in FIGS. 10A to 10C. FIG. 11A indicates a change in a volume of a sound input through the mic unit 11 with respect to a time. FIG. 11B indicates a change in a distance (relative distance) estimated in the detection unit 21 with respect to a time. FIG. 11C indicates a change in a speed (another speed) of the warning devices 52a and 53a estimated in the detection unit 21 with respect to a time. FIG. 11D indicates a change in a relative direction of the warning devices 52a and 53a estimated in the detection unit 21 with respect to a time.

First, when the own vehicle 5 approaches the crossings 52 and 53, the warning sound of the warning devices 52a and 53a is detected. The relative distance is estimated based on a volume of the warning sound, and another speed is estimated in consideration of the Doppler effect (a state shown in FIG. 10A). In this case, since the warning devices 52a and 53a are installed in the crossings 52 and 53, another speed is 0 [km/h].

Here, when the relative distance between the own vehicle 5 and the warning devices 52a and 53a is decreased and it is estimated by a situation estimation processing unit 22 that the own vehicle 5 arrives at the immediate vicinity of the warning devices 52a and 53a, a control signal for a temporary stop is output from the driving control unit 30 to a controlled unit 2. As a result, the own vehicle 5 is temporarily stopped in front of the crossing 52 (a state shown in FIG. 10B). In this case, the driving control unit 30 controls the driving of the own vehicle 5 by additionally considering sensor information such as a video or extremely high frequency radar so that the own vehicle 5 does not collide with a crossing bar of the crossing 52.

The sound input through the mic unit 11 of the own vehicle 5 includes a traveling sound of the train 54 in addition to the warning sound of the warning devices 52a and 53a. If the traveling sound of the train 54 can be specified, whether or not the train 54 has passed through the crossings 52 and 53 can be estimated based on a volume of the traveling sound. At this time, an arrival direction of the train 54 may be estimated and displayed on a display (not shown) provided in the own vehicle 5. In addition, the arrival direction of the train 54 may be output from a speaker (not shown) provided in the own vehicle 5 and announced as a voice.

When the train 54 passes through the crossings 52 and 53 and the warning sound of the warning devices 52a and 53a is stopped, a control signal for restarting the driving is output from the driving control unit 30 to the controlled unit 2. As a result, the driving of the own vehicle 5 restarts (a state shown in FIG. 10C).

As described above, according to the second embodiment, it is possible to realize smooth autonomous driving in which the warning sound of the targets is detected to stop the driving of the own vehicle 5 in front of the warning devices 52a and 53a and the driving of the own vehicle 5 restarts when the warning sound is stopped even in a case where the warning devise 52a and 53a, which are non-moving bodies, are the targets.

Further, if the crossing bar is not included in the crossings 52 and 53, there is a risk that the own vehicle 5 enters the railroad while the train 54 is approaching in merely considering sensor information such as a video or extremely high frequency radar. In contrast, it is possible to certainly stop the own vehicle 5 regardless of the presence or absence of the crossing bar when the method of detecting the warning sound of the warning devices 52a and 53a is used.

### (Hardware Configuration)

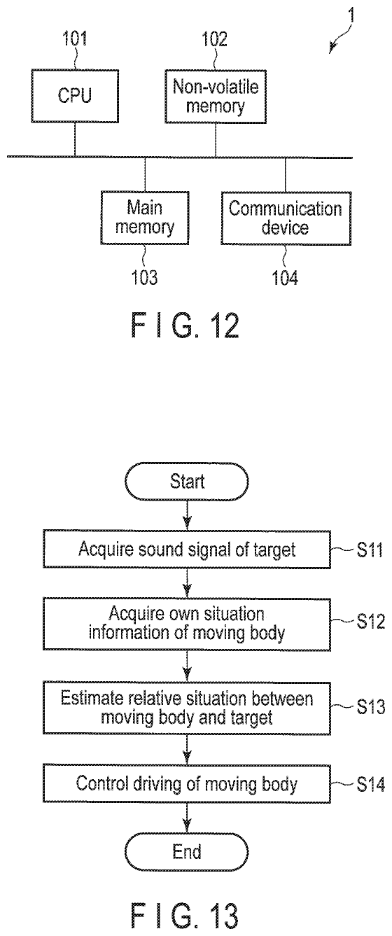

FIG. 12 is a diagram showing an example of a hardware configuration of each of the control apparatuses 1 according to the first and second embodiments.

The control apparatus 1 includes a central processing unit (CPU) 101, a non-volatile memory 102, a main memory 103, a communication device 104, and the like.

The CPU 101 is a hardware processor controlling an operation of various components in the control apparatus 1. The CPU 101 executes various programs loaded from the non-volatile memory 102 which is a storage device to the main memory 103.

The program executed by the CPU 101 includes a program (hereinafter, referred to as a moving body control program) for executing a processing operation shown in a flowchart of FIG. 13, in addition to an operating system (OS). Further, the CPU 101 also executes, for example, a basic input/output system (BIOS) which is a program for controlling the hardware, and the like.

A part or all of the acquisition unit 10, the situation estimation unit 20, and the driving control unit 30 shown in FIG. 1 are implemented by causing the CPU (computer) 101 to execute the moving body control program.

The moving body control program may be distributed while being stored in a computer-readable recoding medium, or may be downloaded to the control apparatus 1 through a network. A part or all of the acquisition unit 10, the situation estimation unit 20, and the driving control unit 30 may be implemented by hardware such as an integrated circuit (IC), or may be implemented by a combination of corresponding software and hardware.

The communication device 104 is a device configured to execute, for example, communication with an external device wirelessly or in a wired manner.

In the example of FIG. 12, only the CPU 101, the non-volatile memory 102, the main memory 103, and the communication device 104 are shown, but the control apparatus 1 may include another storage device, for example, a hard disk drive (HDD) and a solid state drive (SSD). In addition, the control apparatus 1 may include an input device, a display device, a voice output device, and the like.

FIG. 13 is a flowchart showing a processing operation of the control apparatus 1. As described above, the processing shown in the flowchart is executed as the CPU 101, which is the hardware processor, reads the moving body control program.

The CPU 101 acquires a sound signal from a target (emergency vehicle 6) (step S11). The sound signal from the target (emergency vehicle 6) is obtained through the mic unit 11 shown in FIG. 2. In addition, the CPU 101 acquires own situation information of a moving body (own vehicle 5) (step S12). The own situation information of the moving body (own vehicle 5) is obtained through the sensor unit 12 shown in FIG. 2.

Here, the CPU 101 estimates a relative situation between the moving body being a control target and the target based on the sound signal obtained in step S11 (step S13). At this time, situation estimation may be performed by additionally considering the own situation information of the moving body obtained in step S12.

The CPU 101 controls driving of the moving body based on the relative situation between the moving body and the target estimated in step S13 (step S14). In detail, for example, when the target approaches the moving body, the CPU 101 controls the moving body to deviate from a movement route of the target and stop, and terminates a driving control when the target departs, such that the moving body returns to normal driving.

### Modified Example

In the first and second embodiments, an example in which a moving body being a control target is a vehicle has been described. However, the moving body may also be, for example, a self-propelled robot or a flight vehicle.

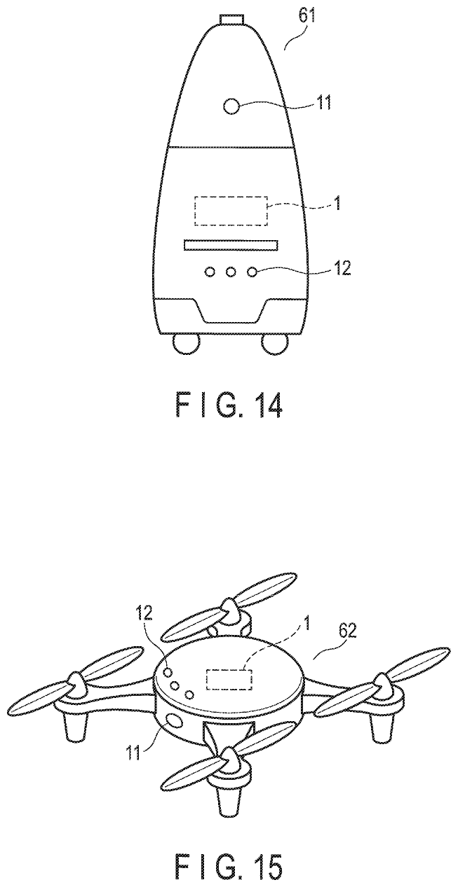

FIG. 14 shows an example of a self-propelled robot.

A robot 61 is, for example, a robot for unmanned monitoring. This robot 61 includes a control apparatus 1 described with reference to FIGS. 1 and 2. The control apparatus 1 acquires a surrounding sound of the robot 61 through a mic unit 11, and acquires own situation information of the robot 61 through a sensor unit 12.

The robot 61 self-travels in a plant, and monitors whether or not a warning sound is issued by a manufacturing apparatus in the plant through the mic unit 11 and whether or not an abnormal sound is made due to failure, fire, or the like. When the warning sound or abnormal sound is detected, the robot 61 is subjected to the driving control so that the own vehicle approaches a place where the sound is made. The robot 61 acquires information such as a model number of the manufacturing apparatus from positional information of the place where the sound is made, or acquires situation information through a video or the like.

Here, when another robot to which traveling priority is given travels while making a warning sound, a relationship between that robot and the robot 61 is the same as that between the emergency vehicle 6 and the own vehicle 5 described above.

FIG. 15 shows an example of a flight vehicle.

A flight vehicle 62 is, for example, a drone (unmanned aircraft). This flight vehicle 62 includes a control apparatus 1 described with reference to FIGS. 1 and 2. The control apparatus 1 acquires a surrounding sound of the flight vehicle 62 through a mic unit 11, and acquires own situation information of the flight vehicle 62 through a sensor unit 12.

The flight vehicle 62 is subjected to driving control so that the flight vehicle 62 moves to a place where a preset sound signal is issued, and acquires situation information through a video or the like. In addition, the flight vehicle 62 detects a sound issued by another flight vehicle and is subjected to the driving control to prevent the flight vehicle 62 from colliding with that flight vehicle.

As described above, even when the self-propelled robot or the fight vehicle is the control target, it is possible to obtain the same effect as those of the first and second embodiments.

It should be noted that, for example, a temperature of a target may be additionally detected as an element other than the sound of the target. By doing so, it is possible to control driving of a moving body being a control target by additionally considering a change in the temperature caused by an approach/departure of a target. Further, for example, electromagnetic waves emitted from the target, or the like may be additionally detected. Autonomous driving using a camera can be applied only at a place where the target can be seen. However, it is possible to realize autonomous driving with high accuracy even at a place where the target cannot be seen by detecting the temperature or the electromagnetic waves, in addition to the sound of the target.

According to at least one of the embodiments described above, it is possible to provide the moving body control apparatus, method, and program capable of realizing smooth autonomous driving of the moving body in consideration of a relative situation between the moving body and the target.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving body control apparatus comprising:
a memory; and
a hardware processor in communication with the memory, the hardware processor configured to:
acquire a sound signal issued by a target;
estimate a relative situation between a moving body as a controlled target and the target based on the sound signal; and
control driving of the moving body based on the estimated situation.

2. The moving body control apparatus according to claim 1, wherein
the relative situation between the moving body and the target includes at least one of a relative direction, a relative speed, and a relative distance of the target with respect to the moving body.

3. The moving body control apparatus according to claim 1, wherein
the hardware processor is further configured to acquire own situation information of the moving body, and estimates the relative situation between the moving body and the target in consideration of the own situation information of the moving body.

4. The moving body control apparatus according to claim 2, wherein
the hardware processor is further configured to acquire own situation information of the moving body, and estimates the relative situation between the moving body and the target in consideration of the own situation information of the moving body.

5. The moving body control apparatus according to claim 3, wherein
the own situation information of the moving body includes at least one of a speed of the moving body, a movement direction of the moving body, and a current position of the moving body.

6. The moving body control apparatus according to claim 4, wherein
the own situation information of the moving body includes at least one of a speed of the moving body, a movement direction of the moving body, and a current position of the moving body.

7. The moving body control apparatus according to claim 1, further comprising:
a learning device which learns a relationship between the relative situation between the moving body and the target and an ideal driving control of the moving body on a movement route of the moving body,
wherein the hardware processor is further configured to perform driving control of the moving body corresponding to the estimated situation with reference to the learning device.

8. The moving body control apparatus according to claim 2, further comprising:
a learning device which learns a relationship between the relative situation between the moving body and the target and an ideal driving control of the moving body on a movement route of the moving body,
wherein the hardware processor is further configured to perform driving control of the moving body corresponding to the estimated situation with reference to the learning device.

9. The moving body control apparatus according to claim 7, wherein
the learning device learns start and end of the driving control of the moving body corresponding to the relative situation between the moving body and the target.

10. The moving body control apparatus according to claim 8, wherein
the learning device learns start and end of the driving control of the moving body corresponding to the relative situation between the moving body and the target.

11. The moving body control apparatus according to claim 1, further comprising
an output device which outputs information indicating detection of the sound signal or a relative direction of the sound signal with respect to the moving body.

12. The moving body control apparatus according to claim 2, further comprising
an output device which outputs information indicating detection of the sound signal or a relative direction of the sound signal with respect to the moving body.

13. The moving body control apparatus according to claim 1, wherein
the moving body includes at least one of a vehicle, a flight vehicle, a vessel, and a self-propelled robot.

14. The moving body control apparatus according to claim 1, wherein
the target is a moving body including at least an emergency vehicle.

15. The moving body control apparatus according to claim 1, wherein
the target is a non-moving body including at least a warning device of a crossing.

16. A moving body control method comprising:
acquiring a sound signal issued by a target;
estimating a relative situation between a moving body being a controlled target and the target based on the sound signal; and
controlling driving of the moving body based on the estimated situation.

17. The moving body control method according to claim 16, wherein
the relative situation between the moving body and the target includes at least one of a relative direction, a relative speed, and a relative distance of the target with respect to the moving body.

18. A non-transitory computer-readable storage medium storing instructions executed by a computer, wherein the instructions, when executed by the computer, cause the computer to perform:
acquiring a sound signal issued by a target;
estimating a relative situation between a moving body being a controlled target and the target based on the sound signal; and
controlling driving of the moving body based on the situation estimated.

19. The storage medium according to claim 18, wherein the relative situation between the moving body and the target includes at least one of a relative direction, a relative speed, and a relative distance of the target with respect to the moving body.
